(19) United States
(12) Patent Application Publication
(10) Pub. No.: US 2008/0019030 A1
(43) Pub. Date: Jan. 24, 2008

(54) Magnetic disk read/write device and method of evaluation of thermal relaxation degradation in magnetic disk read/write device

(75) Inventor: Kaori Nakao, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/904,156

(22) Filed: Sep. 26, 2007

Related U.S. Application Data
(63) Continuation of application No. PCT/JP05/05760, filed on Mar. 28, 2005.

(51) Int. Cl. G11B 27/36; G11B 5/09

(52) U.S. Cl. 360/31; 360/53

(57) ABSTRACT

A method of evaluating thermal relaxation in magnetic recording, and a pass-fail decision method for a magnetic disk read/write device which satisfies lifetime assurance conditions, are provided. The pass-fail decision method for a magnetic disk read/write device is a method of thermal relaxation degradation in a magnetic disk read/write device comprising a magnetic disk and a head which writes to and reads out from the magnetic disk, wherein prescribed signals are written to and recorded on the magnetic disk; the written and recorded signals are repeatedly read out at fixed time intervals over a prescribed time period; the error rate is measured for each reading-out; the relation between the logarithm of the elapsed time and the measured error rate is linearly approximated; and the error rate of the magnetic disk read/write device at a time exceeding the prescribed period is evaluated.

### CROSS REFERENCE TO RELATED APPLICATIONS

This application is a continuation of International Application No. PCT/JP2005/005760, filed on Mar. 28, 2005, now pending, herein incorporated by reference.

### TECHNICAL FIELD

This invention relates to a magnetic disk read/write device and to a method of evaluating thermal relaxation degradation in a magnetic disk read/write device.

### BACKGROUND ART

Data written to magnetic disk recording media has the characteristic of being difficult to read out or reproduce with the passage of time, due to thermal relaxation of the recording media. Here “thermal relaxation” means disordering of the magnetized state, and instability and disorder of the recording magnetization; the influence of the ambient temperature on such relaxation is particularly pronounced.

Further, magnetic particle sizes have grown smaller accompanying the higher densities of magnetic media in recent years, and the ease of magnetization reversal and resulting degradation of performance due to thermal relaxation have become problems. As one method of evaluating performance degradation, changes in electromagnetic transducing characteristics (for example, the amplitude and SN ratio of reproduced signals) have been evaluated.

However, because the error rate, which is the most important characteristic in magnetic recording, is also degraded, there is a need to directly evaluate changes in the error rate. Also, it is important that long-term performance of magnetic disk read/write devices be ensured. To this end, it is important that performance at a time in the future be predicted in advance.

On the other hand, at present, numerous magnetic disk read/write devices are provided with auto-diagnostic functions known as a SMART (Self-Monitoring, Analysis and Reporting Technology System) mechanism. By monitoring information obtained from this mechanism, it may be possible to prevent malfunctions in a magnetic disk read/write device.

Technology of the prior art includes for example the invention disclosed in Patent Document 1, Japanese laid open patent application 2004-62975. In this invention, when a read/write device is used in recording or reproduction, media characteristics are measured by means to diagnose the characteristics of the recording media, and in conjunction with past diagnostic history information, a prediction is made, and conveyed to the user, of the time when a characteristic of the recording media will fall to or below a prescribed value.

Moreover, in Patent Document 2, Japanese laid open patent application Tokukai-Hei 10-255202, when a state obtains in which recorded signals are attenuated due to thermal fluctuations, prior to the occurrence of errors due to thermal fluctuations, write-recording is again performed to suppress the influence of thermal fluctuations.

In the inventions of both Patent Document 1 and Patent Document 2, use is initiated, characteristics are recorded during the process of use, and the time of subsequent degradation is predicted, or rewriting is performed prior to the occurrence of errors due to degradation. Short-term measurement is performed at the time of manufacture, but there is no disclosure of a concept involving judgment as to whether reliability can be assured after a long period is performed.

Here, information obtained from the above-described SMART mechanism is used in such functions as error event logging, and writing and verification at the time of an error occurrence. Hence monitoring of thermal relaxation, and prediction in advance of the performance at a time in the future, are not possible.

With respect to evaluation of thermal relaxation in particular, there are the following problems.

First, in high-temperature environments in particular, the rate of attenuation of the reproduced output and the rate of degradation of the error rate are increased.

Second, in evaluations and testing, it is necessary to determine the performance assurance over a long period of, for example, about five years in a short time.

Third, the amount of degradation due to thermal relaxation differs depending on the combination of magnetic head and recording media and on the recording density, so that it is necessary to evaluate the amount of degradation due to thermal relaxation for each head and each type of recording media.

Fourth, the rate of degradation of the error rate due to thermal relaxation depends on the error rate absolute value, and so a pass-fail decision cannot be made unconditionally based on the amount of degradation observed over a fixed time or on the error rate reached after a fixed time has elapsed.

In light of these problems, and as a result of repeated testing, the inventor confirmed that the aging degradation of the error rate due to thermal relaxation can be approximately linearly with the logarithm of the time elapsed from the time of writing to the recording media, beginning from several minutes afterward.

Hence an object of the invention is to provide a method of evaluation of thermal relaxation degradation in a magnetic disk read/write device, and a magnetic disk read/write device using this method, which solves the first through fourth problems above by performing error rate measurements, based on confirmation of this characteristic.

A further object is to provide a method of evaluation of thermal relaxation in magnetic recording, and a pass-fail decision method for magnetic disk read/write devices which satisfies lifetime assurance conditions.

### SUMMARY OF THE INVENTION

A first aspect of a method of this invention for evaluation of thermal relaxation degradation which attains the above objects, in a magnetic disk read/write device having a magnetic disk and a head which writes to and reads from the magnetic disk, is characterized in that prescribed signals are written to and recorded on the magnetic disk; the written and recorded signals are repeatedly read out at fixed time intervals over a prescribed time period; the error rate is measured for each reading-out; the relation between the logarithm of an elapsed time and the measured error rate is linearly approximated; and the error rate of the magnetic disk read/write device at a time exceeding the prescribed period is evaluated.

A second aspect of a method of this invention for evaluation of thermal relaxation degradation in a magnetic disk read/write device which attains the above objects, is the method of the first aspect, in which the linear approximation is determined by linear interpolation from the measured error rate.

A third aspect of a method of this invention for evaluation of thermal relaxation degradation in a magnetic disk read/write device which attains the above objects, is the method of the first aspect, in which the fixed intervals are units of from 1 to 2 seconds.

A fourth aspect of a method of this invention for evaluation of thermal relaxation degradation in a magnetic disk read/write-device which attains the above-objects, is the method of the first aspect, in which, in addition, the prescribed signals are again written and recorded, reading-out is performed, the error rate is measured, and the error rate is compared with the error rate measured in the previous write-recording and reading-out, and when the error rates are the same, the magnetic head is judged to be defective.

A magnetic disk read/write device of the invention which attains the above objects is characterized in that prescribed signals are written to and recorded on the magnetic disk; the written and recorded signals are repeatedly read out at fixed time intervals over a prescribed time period; the error rate is measured for each reading-out; the relation between the logarithm of an elapsed time and the measured error rate is linearly approximated; and the error rate at a time exceeding the prescribed period is evaluated.

Characteristics of the invention will become clear through aspects of the invention which are explained below, referring to the drawings.

### BRIEF DESCRIPTION OF THE DRAWINGS

FIG. 1 is a diagram of a system for implementing a method of evaluating thermal relaxation degradation to attain objects of this invention, in a magnetic disk read/write device;

FIG. 2 is a processing flow diagram for a method of evaluating thermal relaxation degradation to attain objects of this invention, in a magnetic disk read/write device; and

FIG. 3 explains evaluation of thermal relaxation degradation in a magnetic disk read/write device which attains objects of this invention.

### PREFERRED EMBODIMENTS OF THE INVENTION

Below, aspects of the invention are explained referring to the drawings. The aspects are intended to facilitate understanding of the invention, and the technical scope of the invention is not limited to these aspects.

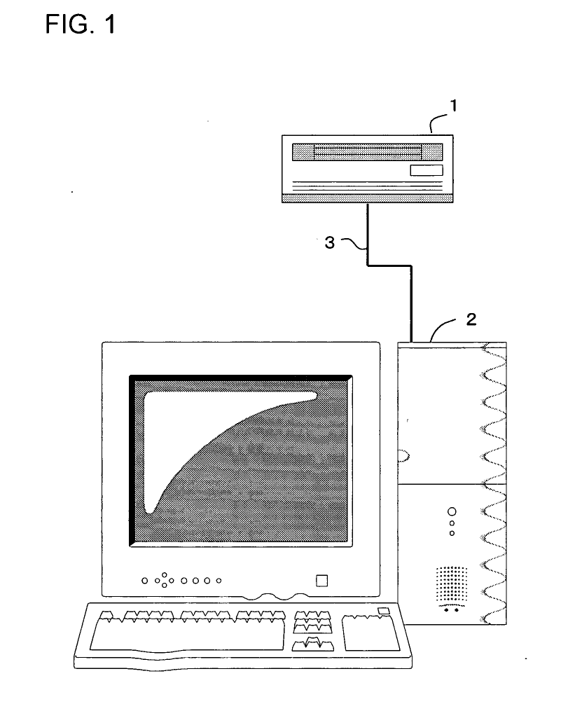

FIG. 1 shows the configuration of a system for implementing a method for evaluating thermal relaxation degradation in a magnetic disk read/write device, which attains objects of the invention. The magnetic disk read/write device 1 is connected by a cable 3 to a computer 2, and evaluative measurements are performed.

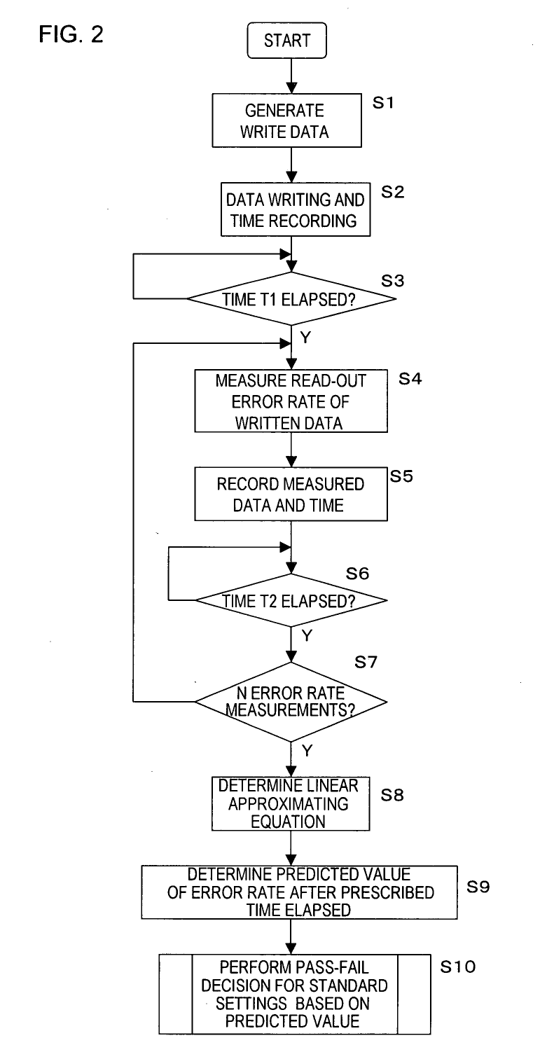

FIG. 2 shows the processing flow of a method of this invention for evaluating thermal relaxation degradation in a magnetic disk read/write device, using the system shown in FIG. 1.

In FIG. 2, first data to be written to the magnetic disk read/write device 1 is generated in the computer 2 (step S1).

The generated data is written to the magnetic disk by the computer 2, and the time at which the data is written is recorded (step S2). At time T1 after writing the generated data, for example after one to two minutes have elapsed (Y in step S3), the previously written data is read out, and the error rate is measured (step S4).

Here, any method may be used to measure the error rate in step S4; for example, the ER (error rate) or S/N (signal-to-noise ratio) can be used as an index.

The VMM (Viterbi Metric Margin) can also be used to measure the error rate. In this aspect, any of these measurement methods can be employed.

That is, similarly to the ER (error rate) and S/N (signal-to-noise ratio), the VMM can be used as an index indicating the signal quality in a magnetic disk read/write device.

In the field of magnetic recording, the Viterbi decoding method is widely used as a method of judging whether data has been received correctly. The Viterbi decoding method is a decoding method (maximum-likelihood decoding) in which, for a path of continuous 0/1 data, analogous values are compared with actually received data, and symbols thought to be the most correct are determined as the read-out values. The VMM is a function conceived as a means of measuring signal quality during Viterbi decoding; the margin between the received data path and the analogous erroneous path is determined, and if the difference is small (if close to the erroneous path), the received data is judged to be erroneous.

Returning to FIG. 2, the error rate data measured as described above is recorded together with the time of measurement (step S5).

Then, after time T2, for example each time 1 to 2 seconds have elapsed (Y in step S6), the error rate is similarly measured, and this is repeated N times (Y in step S7).

Based on the data of N actual such measurements, a linear approximation is determined (step S8).

That is, the measurement times after every elapsed time T2 are represented logarithmically, and straight-line interpolation between two measurement data items is performed.

Prior to explaining the actual linear interpolation, an explanation using general equations in (X,Y) is given.

With Y=log(VMM), X=log(t), the relation is expressed by the first-order equation Y=A×X+B.

If log(VMM) at times X1 and X2 are respectively Y1 and Y2, then the relation can be expressed as Y2−Y1=A(X2−X1), and so
A(slope)=(Y2−Y1)/(X2−X1)

Hence Y at time X is
Y=(Y2−Y1)/(X2−X1)×(X−X1)+Y1 (1)

Here, VMM at time X1 is VMM_X1, and VMM at time X2 is VMM_X2.

Y=log(X) at time X is
Y=(log(VMM_{—}X2)−log(VMM_{—}X1))/(logX2−logX1)×(logX−logX1)+log(VMM_{—}X1) (2)

Here, substituting specific figures for head “a” and head “b”, let the VMM for head “a” at T1=1000 sec be VMM_T1a and the VMM for head “b” at T1=1000 sec be VMM_T1b, and similarly let the VMM values at T2=10000 sec be VMM_T2a for head “a” and VMM_T2b for head “b”.

When measurements yield VMM_T1a=200, VMM_T1b=300, VMM_T2a=300, and VMM_T2b=700, then linear approximations are obtained as follows. For head “a”:
Y=(log(300)−log(250))/(log10000−log1000)×(logTx−log1000)+log(250) (3)

and for head “b”:
Y=(log(700)−log(450))/(log10000−log1000)×logTx−log1000)+log(450) (4)

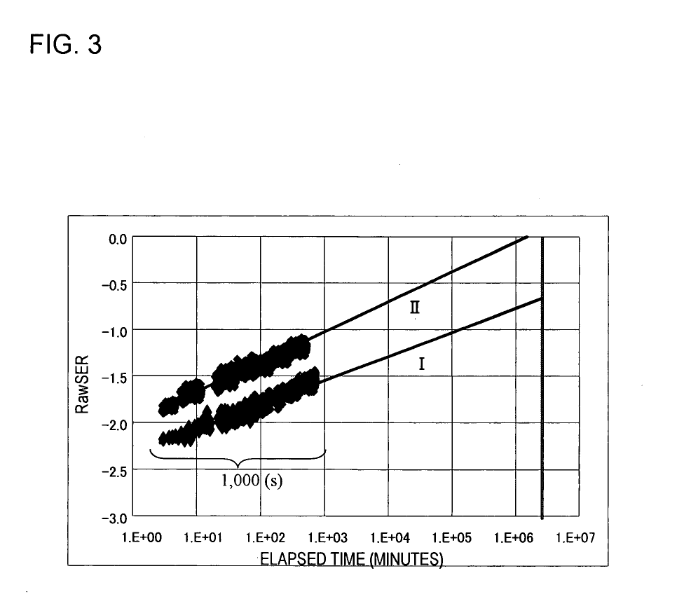

FIG. 3 shows in a graph the linear approximations thus obtained. In FIG. 3, the straight lines I, II represent linear approximating equations determined for the above-described two different heads “a” and “b”. The linear approximating equations were obtained based on VMM values obtained at measurement times of at greatest 1000 seconds.

Hence by substituting as Tx the number of seconds equivalent to a prescribed number of elapsed years, a prediction value for the VMM value after the number of elapsed years can be obtained (step S9).

Thus by means of this invention, measurements over a short time can be used to make a pass-fail decision as to whether the error rate at the maximum number of years of an assurance period for a magnetic disk read/write device is within standards (step S10).

In the above, the measured error rate is the total error rate for the magnetic disk read/write device. On the other hand, factors contributing to the error rate may include defects in the media itself, and defects in the read/write heads. Hence it is important that factors giving rise to the error rate be discriminated between those for the recording media, and those for the read/write heads.

As one method to achieve this, prescribed signals are again written and recorded, read-out is performed, and the error rate is measured. Then, the results are compared with the error rates measured upon previous write-recording and read-out operations. In this comparison, if the error rates are the same, the magnetic head can be judged to be defective.

### INDUSTRIAL APPLICABILITY

By applying this invention as described above, pass-fail decisions for magnetic disk read/write devices after a long period has elapsed can easily be performed based on measurements over a short time, and so magnetic disk read/write devices meeting product standards can be efficiently selected and shipped.

1. A method of evaluation of thermal relaxation degradation in a magnetic disk read/write device including a magnetic disk and a head which performs writing to and reading from the magnetic disk, the method comprising the steps of:
writing and recording prescribed signals onto the magnetic disk;
repeatedly reading out, at fixed time intervals, the written and recorded signals over a prescribed time period;
measuring the error rate upon each the reading-out;
linearly approximating the relation between the logarithm of an elapsed time and the measured error rate; and
evaluating the error rate of the magnetic disk read/write device at a time exceeding the prescribed time period.

2. The method of evaluation of thermal relaxation degradation in a magnetic disk read/write device according to claim 1, wherein the linear approximation is determined by linear interpolation from the measured error rate.

3. The method of evaluation of thermal relaxation degradation in a magnetic disk read/write device according to claim 1, wherein the fixed time intervals are units of from 1 to 2 seconds.

4. The method of evaluation of thermal relaxation degradation in a magnetic disk read/write device according to claim 1, further comprising the steps of:
again writing and recording the prescribed signals, performing reading-out, and measuring the error rate;
comparing the error rate with the error rate measured in the previous write-recording and reading-out; and
judging the magnetic head to be defective when the error rates are the same.

5. A magnetic disk device comprising:
a magnetic disk; and
a head which performs writing to and reading-out from the magnetic disk, wherein
prescribed signals are written and recorded onto the magnetic disk;
at fixed time intervals, the written and recorded signals are repeatedly read out over a prescribed time period;
the error rate is measured upon each the reading-out;
the relation between the logarithm of an elapsed time and the measured error rate is linearly approximated; and
the error rate at a time exceeding the prescribed time period is evaluated.
